(19) United States
(12) Patent Application Publication
(10) Pub. No.: US 2011/0178197 A1
(43) Pub. Date: Jul. 21, 2011

(54) Nonflammable hollow polymeric microspheres

(75) Inventors: Richard F. Clark, Eden, NY (US); Jessica Killion, North Tonawanda, NY (US)

(73) Assignee: Henkel Corporation, Rocky Hill, CT (US)

(21) Appl. No.: 13/075,781

(22) Filed: Mar. 30, 2011

Related U.S. Application Data
(63) Continuation of application No. PCT/US2009/058525, filed on Sep. 28, 2009.
(60) Provisional application No. 61/101,367, filed on Sep. 30, 2008.

(51) Int. Cl. C08F 214/10; C08F 220/06; C08K 3/22

(52) U.S. Cl. 521/145; 521/149; 524/437

(57) ABSTRACT

Hollow polymeric microspheres may be rendered nonflammable by coating with one or more flame retardants, while maintaining a composite density of not greater than 0.05 g/cm3.

### FIELD OF THE INVENTION

The present invention relates to expanded hollow polymeric microspheres that are nonflammable, as well as methods for preparing nonflammable microspheres.

### DISCUSSION OF THE RELATED ART

Expanded hollow microspheres based on thermoplastic polymers are well known in the art and are commonly used as low density fillers in various types of compositions such as coatings, adhesives, sealants and composites. Typically, the microspheres are prepared by emulsion polymerization of one or more monomers in the presence of one or more volatile substances such as a light (low boiling) hydrocarbon or halogenated organic compound. The monomers polymerize to form a shell that encapsulates the volatile substances. The resulting microspheres are then heated to effect expansion of the shells as a result of the internal pressure created by the volatile substances together with a softening of the thermoplastic resulting from polymerization of the monomers. To help minimize agglomeration of the expanded microspheres and to provide such microspheres in free-flowing form, it is known to coat the outer surfaces of the microspheres with a processing aid such as calcium carbonate. See, for example, U.S. Pat. Nos. 4,722,943 and 5,180,752. In many applications, it is desirable for such microspheres to have as low a density as possible in order to reduce the weight and/or cost of the article prepared using the microspheres. However, it has been found that low density calcium carbonate-coated expanded microspheres can be flammable solids and thus may represent an explosion hazard. For example, microspheres having a composite density of 0.030 g/cm³ and containing 65 weight percent calcium carbonate as a coating (based on the total weight of microspheres and calcium carbonate) are flammable. It would therefore be advantageous to develop methods for rendering low density microspheres nonflammable so as to reduce the safety issues involved in handling such materials.

### BRIEF SUMMARY OF THE INVENTION

The invention provides hollow polymeric microspheres coated with one or more flame retardants, wherein said flame retardants are present in an amount effective to render the microspheres nonflammable while maintaining a composite density of not greater than 0.05 g/cm³.

Also provided by the invention is a method of rendering hollow polymeric microspheres nonflammable, said method comprising forming a coating of one or more flame retardants on said hollow polymeric microspheres, wherein said flame retardants are present in said coating in an amount effective to render the microspheres nonflammable while maintaining a composite density of not greater than 0.05 g/cm³.

A method is further provided by the invention which comprises exposing hollow polymeric microspheres to a potential ignition source, wherein said hollow polymeric microspheres have an outer coating of one or more flame retardants and wherein said flame retardants are present in said coating in an amount effective to render the microspheres nonflammable while maintaining a composite density of not greater than 0.05 g/cm³.

An especially preferred embodiment of the invention provides a product comprised of hollow polymeric microspheres coated with at least 35 weight percent aluminum trihydroxide particles, wherein said product is nonflammable and has a composite density of not greater than 0.05 g/cm³, at least a portion of the aluminum trihydroxide particles are thermally bonded to the hollow polymeric microspheres, and the aluminum trihydroxide particles have a median particle size of about 3 to about 8 microns and a surface area of about 2 to about 15 m²/g.

### DETAILED DISCUSSION OF CERTAIN EMBODIMENTS OF THE INVENTION

In the context of the present invention, “nonflammable” means a substance that when tested in accordance with the United Nations/Department of Transportation Burning Rate test (for Readily Combustible Solids, Division 4.1, Test N.1) described in Section 33 (“Classification Procedures, Test Methods and Criteria Relating to Class 4”) of the Fourth Revised Edition of the Recommendations of the Transport of Dangerous Goods Manual of Tests and Criteria exhibits a burn time over 100 mm of greater than 45 seconds. A summary of this test procedure is as follows: A sample in powder form is filled into a mold 250 mm long with a triangular cross section of height 10 mm and width 20 mm. After tapping the mold to settle the sample, it is inverted onto an impervious non-combustible plate of low thermal conductivity. The mold is removed and the ignition source (flame or hot wire above 1000 degrees C.) is placed at one end of the sample train for 2 minutes or until the sample ignites. When the sample has burned a distance of 80 mm, the rate of burning over the next 100 mm is measured. The test is repeated 6 times using a cool clean plate each time.

A variety of different substances may be employed as the flame retardant component of the present invention, including both inorganic and organic materials. A single flame retardant or a mixture of different flame retardants may be utilized. Suitable illustrative flame retardants include, but are not limited to, metal and alkaline earth metal hydroxides (with aluminum trihydroxide, also sometimes referred to as alumina trihydrate, ATH, aluminum hydroxide, aluminum hydrate, hydrated alumina, or hydrated aluminum oxide, being especially preferred), melamines (including pure melamine as well as melamine derivatives), ammonium polyphosphates (APP, including both short chain and long chain APP), zinc borates, organophosphorus compounds (including non-halogenated organophosphorus compounds such as phosphate esters, phosphonium derivatives, and phosphonates as well as halogenated organophosphorus compounds such as tris(1-chloro-2-propyl)phosphate and tris(2-chloroethyl)phosphate), and halogenated compounds (e.g., brominated flame retardants such as polybrominated diphenyl ethers and polybrominated biphenyls). The surface of such flame retardants may be treated or modified (for example, an ammonium polyphosphate may be coated with melamin). Flame retardants useful in the present invention are readily available from a number of commercial sources including the melamine-based flame retardants sold under the MELAPUR brand by Ciba, under the MELAGARD brand by Italmatch, and under the BUDIT brand by Budenheim, the organophosphorus flame retardants sold under the ANTIBLAZE brand by Albemarle, under the EXOLIT brand by Clariant, under the REOGARD, KRONITEX and REOFOS brands by Chemtura, and under the MASTERET and PHOSLITE brands by Italmatch, ammonium polyphosphate flame retardants sold under the ANTIBLAZE brand by Albemarle, under the EXOLIT brand by Clariant, and under the FR CROS brand by Budenheim, the metal and alkaline earth metal hydroxides sold under the MAGNIFIN and MARTINAL brands by Albemarle, under the TIMONOX, FIRESHIELD, THERMOGUARD, PYROBLOC, MICROFINE, and ULTRAFINE brands by Chemtura, and under the MICRAL brand by J. M. Huber as well as the various aluminas sold by Alcan, halogenated flame retardants sold under the SAYTEX brand by Albemarle and under the FIREMASTER brand by Chemtura, and the zinc borate flame retardants sold under the FIREBRAKE brand by Luzenac as well as those sold by Chemtura.

Preferably, the flame retardant is solid rather than liquid and in the form of finely divided particles, i.e., solid particles which are relatively small in size. It will be advantageous to employ flame retardants that are free flowing solids having a melting or softening point higher than that of the hollow polymeric microspheres. In certain embodiments of the invention, the flame retardant used has a median particle size of about 0.01 to about 20 microns or about 0.1 to about 10 microns, most preferably in the range of from about 3 to about 8 microns. Particle size can be measured by use of a Malvern Mastersizer, S laser diffraction. Although the surface area of the flame retardant is not believed to have a particularly significant effect on its performance, typically the flame retardant will have a surface area of about 2 to about 15 m²/g, as measured with a Quantachrome monosorb surface area analyzer.

In preferred embodiments of the invention, the flame retardant selected is substantially free of halogens and heavy metals. Useful flame retardants include substances such as aluminum trihydroxide that undergo an endothermic reaction to release water when heated to an elevated temperature, e.g., at least about 200 degrees C.

The particles of flame retardant may be regular or irregular in shape, e.g., spherical, rod-like, fibrous, platelet, and so forth. In certain embodiments, at least a portion of the flame retardant particles is embedded and/or bound to the outer surfaces of the microspheres. This can be accomplished, for example, by heating an admixture of expandable microspheres and flame retardant particles at a temperature effective to soften the polymer shells of the microspheres, allowing the microspheres to expand, and then cooling the microspheres below the softening point of the polymer, thereby allowing the particles of the flame retardant to become physically attached to the microsphere outer surface (such microspheres may be referred to as having thermally clad or thermally bound coatings).

One or more synergists may be used in combination with the flame retardant(s) to enhance, improve or otherwise advantageously modify the flammability properties of the flame retardant-coated microspheres of the present invention. For example, an antimony oxide synergist may be employed. The synergist may be admixed with the flame retardant (e.g., the coating on the microspheres may comprise discrete particles of flame retardant and synergist) or the synergist may be blended with the flame retardant (e.g., the individual particles of the microsphere coating may comprise both flame retardant and synergist) or the flame retardant particles may be coated or otherwise treated with the synergist.

In accordance with the invention, one or more flame retardants are coated onto hollow polymeric microspheres coated with one or more flame retardants, wherein said flame retardants are present in an amount effective to render the microspheres nonflammable while maintaining a composite density of not greater than 0.05 g/cm³. In the context of this invention, “composite density” means the density of the microspheres in combination with one or more additional materials (e.g., flame retardant) coated on, adhered to or mixed with the thermoplastic shells. “Microsphere density”, as used herein, means the density of the microspheres (the thermoplastic shells) as measured or calculated in the absence of any further material coated on, adhered to, or mixed with the microspheres themselves. When a coating is present on the outer surface of the microspheres, the microsphere density may be calculated from the measured composite density using the known weight ratios of the microspheres and material(s) (e.g., flame retardant) used to prepare the coated microspheres. In certain embodiments of the invention, the composite density of the flame retardant-coated microspheres is not greater than 0.05 g/cm³ or not greater than 0.04 g/cm³ (for example, the microspheres may have a composite density of from 0.002 to 0.05 g/cm³ or from 0.008 to 0.035 g/cm³).

Although the size of the microspheres is not believed to be particularly critical, typically the microspheres useful in the present invention will have diameters when expanded that on average are from about 5 microns to about 500 microns or from about 100 to about 300 microns. In one embodiment, the mode particle size (diameter) of the microspheres is from about 50 to about 150 microns, where the mode particle size is the particle size value that occurs most often (sometimes also referred as the norm particle size).

The present invention is particularly useful for increasing the flame resistance of microspheres having relatively thin shells, while not increasing the composite density of the microspheres to an unacceptable extent. Typically, the average shell thickness is from about 0.01 microns to about 0.5 microns, e.g., about 0.05 to about 0.3 microns.

Methods of preparing expandable hollow polymeric microspheres are well-known in the art and are described, for example, in the following U.S. patents and published applications, each of which is incorporated herein by reference in its entirety: Nos. 3,615,972; 3,864,181; 4,006,273; 4,044,176; 6,235,394; 6,509,384; 6,235,800; 5,834,526; 5,155,138; 5,536,756; 6,903,143; 6,365,641; 7,351,752; 6,903,143; 2008-0017338; 2007-0287776; 2007-0208093; and 2005-0080151, as well as published PCT applications WO2007/046273 and WO2007/058379, each of which is also incorporated herein by reference in its entirety.

Methods of expanding hollow polymeric microspheres containing blowing agents are also well-known in the art and are described, for example, in certain of the patents mentioned in the immediately preceding paragraph as well as the following U.S. patents and published applications, each of which is incorporated herein by reference in its entirety: Nos. 5,484,815; 7,192,989 and 2004-0176487. Where the expandable hollow polymeric microspheres are in the form of a wet cake, drying of the microspheres can be carried out together with microsphere expansion.

In a particularly preferred embodiment of the present invention, the preparation of hollow polymeric microspheres containing an adherent outer coating of flame retardant is carried out by adaptation of the methods known in the art for preparing thermally clad microspheres having particulate processing aids adhered to their outer surfaces, as described, for example, in the following U.S. patents and published applications, each of which is incorporated herein by reference in its entirety: Nos. 4,722,943; 4,829,094; 4,843,104; 4,888,241; 4,898,892; 4,898,894; 4,908,391; 4,912,139; 5,011,862; 5,180,752; 5,580,656; 6,225,361; 5,342,689; 7,368,167 and 2005-0282014. In particular, where expandable microspheres containing one or more volatile expansion agents are used as the starting material, coating of the microspheres with the flame retardant(s) may be carried concurrently or sequentially in coordination with drying and expansion.

Hollow polymeric microspheres can be made from a rather wide diversity of thermoplastic polymers (including crosslinked thermoplastic polymers). In at least certain embodiments of the invention, the microspheres are comprised of one or more polymeric materials which are homopolymers or copolymers (it being understood that this term includes terpolymers, tetrapolymers, etc.) of one or more monomers selected from the group consisting of vinylidene chloride and acrylonitrile (wherein the vinylidene chloride and acrylonitrile may be copolymerized with each other and/or with other types of ethylenically unsaturated monomers). In one embodiment, the polymeric material used to form the microspheres is selected to have a Tg (glass transition temperature) of at least about 50 degrees C.

Suitable polymers for the formation of hollow polymeric microspheres for use in the present invention include materials which are effective vapor barriers to the expansion agent at expansion temperatures, and which have adequate physical properties to form self-supporting expanded microspheres. The characteristics of the microspheres should be selected to be compatible with the properties and expected use temperature of the compositions and articles in which the microspheres are eventually to be incorporated.

The microspheres useful in the present invention may be manufactured using polymers obtained by polymerizing one or more ethylenically unsaturated monomers such as vinylidene chloride, vinylidene dichloride, vinyl chloride, acrylonitrile, methacrylonitrile, alkyl acrylates and alkyl methacrylates, including methyl methacrylate, methyl acrylate, butyl acrylate, butyl methacrylate, isobutyl methacrylate, stearyl methacrylate, and other related acrylic monomers such as 1,3-butylene dimethacrylate, allyl methacrylate, trimethylolpropane trimethacrylate, trimethylolpropane triacrylate, 1,4-butanediol dimethacrylate, 1,3-butanediol dimethacrylate, isobomyl methacrylate, dimethylaminoethyl methacrylate, hydroxyethyl methacrylate, hydroxypropyl methacrylate, diurethane dimethacrylate, and ethylene glycol dimethacrylate. Other monomers such as, for example, vinyl aromatic compounds, olefins and the like, may be included in the polymer, typically in minor proportions.

The monomers used to prepare the polymer may comprise multifunctional monomers which are capable of introducing crosslinking. Such monomers include two or more carbon-carbon double bonds per molecule which are capable of undergoing addition polymerization with the other monomers. Suitable multifunctional monomers include divinyl benzene, di(meth)acrylates, tri(meth)acrylates, allyl (meth)acrylates, and the like. If present, such multifunctional monomers preferably comprise from about 0.1 to about 1 weight percent or from about 0.2 to about 0.5 weight percent of the total amount of monomer. In one embodiment, the thermoplastic is a terpolymer of acrylonitrile, vinylidene chloride and a minor proportion (normally less than 5% by weight) of divinyl benzene.

In another embodiment, the polymer is a copolymer containing 0-80% by weight vinylidene chloride, 0-75% by weight acrylonitrile, and 0-70% by weight methyl methacrylate. In still another embodiment, the polymer is prepared by copolymehzation of 0-55% by weight vinylidene chloride, 40-75% by weight acrylonitrile, and 0-50% by weight methyl methacrylate. For example, the polymer may be a methyl methacrylate-acrylonitrile copolymer, a vinylidene chloride- acrylonitrile copolymer or a vinylidene chloride-acrylonitrile-methyl methacrylate copolymer.

The coating process described in U.S. Pat. No. 5,180,752 (incorporated herein by reference in its entirety) is especially useful in the practice of the present invention, wherein one or more flame retardants are substituted for at least a portion of the barrier coating material. Such a coating process is based on separate and distinct sequential steps of first mixing and drying of the expandable microspheres (initially in the form of a wet cake) and the flame retardant(s), under conditions of relatively high shear, and then expanding the dry microspheres to the desired density and causing the flame retardant(s) to thermally bond to the surface thereof. Preferably, the flame retardant-coated microspheres thereby obtained are dry, free-flowing and substantially free of water and agglomerates microspheres agglomerated with each other).

The flame retardant is used in the present invention in an amount sufficient to render the microspheres nonflammable, while achieving a final microsphere composite density of not greater than 0.05 g/cm³. While this amount will vary depending on the particular microspheres and flame retardant(s) employed, and with the particular processing conditions, the total amount of flame retardant will most often be in the range of about 5 to about 90 or about 10 to about 75 weight percent of the mixture of flame retardant and microspheres, on a dry weight basis. For example, when the desired expanded microsphere density is about 0.02 g/cm³, the microsphere shells are comprised of an acrylonitrile copolymer and the flame retardant used is an aluminum trihydroxide having a specific gravity of 2.42 g/cm³, a median particle size of 3.5 microns, and a surface area of 6-8 m²/g, it has been found that a minimum of about 35 weight percent flame retardant is required to render the microspheres nonflammable (the composite density of the flame retardant-coated expanded microspheres thereby obtained will be about 0.033 g/cm³). The upper limit of the amount of flame retardant will be controlled and varied such that the composite density of the flame retardant-coated expanded microspheres is not greater than 0.05 g/cm³.

The coated microspheres according to the invention may be utilized as low density fillers or components in a wide variety of end uses, including plastics, composites, resins, paper, textiles, sealants and adhesives. The microspheres can reduce product weight and lower volume costs by extending or displacing more costly components of such products. Additionally, the flame retardant present as a coating on the microspheres can assist in reducing the flammability of a formulated product containing the microspheres.

### EXAMPLES

A number of different flame retardants were thermally bonded onto microspheres using the methods set forth in U.S. Pat. No. 5,180,752, wherein a wet cake of expandable microspheres is mixed with the flame retardant and water removed by continuous mixing at high shear, followed by a subsequent expansion step. An expanded microsphere density of about 0.019 g/cm³ was achieved. Table 1 sets forth the flame retardants tested, the relative weight proportions of the flame retardants and the microspheres, and the results obtained when the flammability of the flame retardant-coated microspheres was evaluated using procedures consistent with the United Nations/Department of Transportation Burning Rate test (for Readily Combustible Solids, Division 4.1, Test N.1) described in Section 33 (“Classification Procedures, Test Methods and Criteria Relating to Class 4”) of the Fourth Revised Edition of the Recommendations of the Transport of Dangerous Goods Manual of Tests and Criteria. A hot ignition wire was used, except where otherwise indicated.

TABLE 1

| Flame | | Wt. % | | | Burn Time |
|---|---|---|---|---|---|
| Retardant | | Flame | Wt. % | | over 100 |
| Type | Brand Name | Retardant | Microspheres | Flammable? | mm (sec) |
| Magnesium | MAGNIFIN H5 | 65 | 35 | Yes | 8 |
| Hydroxide | | | | | |
| Magnesium | MAGNIFIN H10 | 65 | 35 | Yes | 8 |
| Hydroxide | | | | | |
| Aluminum | MICRAL 632 | 25 | 75 | Yes | 29 |
| Trihydroxide | | | | | |
| Aluminum | MICRAL 632 | 32 | 68 | Yes | 24 |
| Trihydroxide | | | | | |
| Aluminum | MICRAL 632 | 35 | 65 | No | 73 |
| Trihydroxide | | | | | |
| Aluminum | MICRAL 632 | 40 | 60 | No | 86 |
| Trihydroxide | | | | | |
| Zinc Borate | FIREBRAKE | 65 | 35 | No | Ignited briefly, |
| | ZB-Fine | | | | then out |
| Zinc Borate | FIREBRAKE | 57.5 | 42.5 | Yes | 16 |
| | ZB-Fine | | | | |
| Zinc Borate | FIREBRAKE | 65 | 35 | Probably | 8 sec. over 45 |
| | ZB-XF | | | | mm, then out |
| Zinc Borate | FIREBRAKE | 57.5 | 42.5 | Yes | 9 |
| | ZB-XF | | | | |
| APP Phase II | FR CROS S 10 | 65 | 35 | No | No ignition |
| APP Phase II | FR CROS S 10 | 35 | 65 | No | No ignition |
| APP Phase II | FR CROS S 10 | 25 | 75 | No | No ignition |
| APP Phase II | FR CROS S 10 | 20 | 80 | Yes | 22 |
| APP Phase II | FR CROS S 10 | 15 | 85 | Yes | 12 |
| APP Phase II | FR CROS XS 10 | 35 | 65 | No | Ignited, but |
| | | | | | flame did not |
| | | | | | propagate |
| APP Phase II | FR CROS XS 10 | 25 | 75 | Yes | 14 |
| APP Phase II | FR CROS C 30 | 35 | 65 | No? | Ignited, but no |
| (Melamine | | | | | flame spread |
| Coated) | | | | | |
| APP Phase II | FR CROS C 30 | 25 | 75 | No? | Ignited, but no |
| (Melamine | | | | | flame spread |
| Coated) | | | | | |
| APP Phase II | FR CROS C 30 | 25 | 75 | Yes | 19 (butane |
| (Melamine | | | | | lighter) |
| Coated) | | | | | |

1. Hollow polymeric microspheres coated with one or more flame retardants, wherein said flame retardants are present in an amount effective to render the microspheres nonflammable while maintaining a composite density of not greater than 0.05 g/cm³.

2. (canceled)

3. Hollow polymeric microspheres in accordance with claim 1, having a composite density within the range 0.008 to 0.04 g/cm³.

4. Hollow polymeric microspheres in accordance with claim 1, wherein said one or more flame retardants are selected from the group consisting of metal and alkaline earth metal hydroxides, melamines, ammonium polyphosphates, zinc borates, organophosphorus compounds, and halogenated compounds.

5. Hollow polymeric microspheres in accordance with claim 1, wherein said hollow polymeric microspheres are coated with one or more synergists in addition to said one or more flame retardants.

6. Hollow polymeric microspheres in accordance with claim 1, comprising 5 to 90 weight percent of said one or more flame retardants based on the total weight of the composite hollow polymeric microspheres.

7. Hollow polymeric microspheres in accordance with claim 1, wherein said one or more flame retardants are thermally bonded to the outside surface of said hollow polymeric microspheres.

8.-14. (canceled)

15. Hollow polymeric microspheres in accordance with claim 1, wherein said one or more flame retardants used to coat said hollow polymeric microspheres are free flowing solids having a softening or melting point higher than that of said hollow polymeric microspheres.

16. Hollow polymeric microspheres in accordance with claim 1, wherein said hollow polymeric microspheres have shells comprised of a thermoplastic selected from the group consisting of methyl methacrylate-acrylonitrile copolymers, vinylidene chloride-acrylonitrile copolymers and vinylidene chloride-acrylonitrile-methyl methacrylate copolymers.

17. (canceled)

18. Hollow polymeric microspheres in accordance with claim 1, wherein said hollow polymeric microspheres have shells comprised of a polymer obtained by polymerization of one or more acrylic monomers, optionally in combination with one or more non-acrylic monomers.

19. Hollow polymeric microspheres in accordance with claim 18, wherein said one or more acrylic monomers comprise acrylonitrile.

20.-21. (canceled)

22. Hollow polymeric microspheres in accordance with claim 1, wherein said one or more flame retardants comprise aluminum trihydroxide.

23. A method of rendering hollow polymeric microspheres nonflammable comprising:
providing hollow polymeric microspheres having a density of from about 0.005 g/cm³ to about 0.025 g/cm³;
providing one or more flame retardants that are free flowing solids having a softening or melting point higher than that of said hollow polymeric microspheres;
forming a coating of said one or more flame retardants on said hollow polymeric microspheres, wherein said flame retardants are present in said coating in an amount effective to render the microspheres nonflammable while maintaining a composite density of not greater than 0.05 g/cm³.

24.-39. (canceled)

40. A method in accordance with claim 22, wherein said hollow polymeric microspheres have shells comprised of a polymer obtained by polymerization of one or more acrylic monomers, optionally in combination with one or more non-acrylic monomers.

41. A method in accordance with claim 39, wherein said one or more acrylic monomers comprise acrylonitrile.

42.-44. (canceled)

45. A product comprised of hollow polymeric microspheres coated with at least 35 weight percent aluminum trihydroxide particles, wherein said product is nonflammable and has a composite density of not greater than 0.05 g/cm³, at least a portion of the aluminum trihydroxide particles are thermally bonded to the hollow polymeric microspheres, and the aluminum trihydroxide particles have a median particle size of about 0.1 to about 10 microns and a surface area of about 2 to about 15 m²/g.
